(19) United States
(12) Patent Application Publication
(10) Pub. No.: US 2013/0020060 A1
(43) Pub. Date: Jan. 24, 2013

(54) HEAT EXCHANGER

(71) Applicants: George Moser, Brighton, MI (US); Adam Ostapowicz, Orchard Lake Village, MI (US); Lawrence C. Kennedy, Baldwin, MI (US); Randy Linn, Charlotte, MI (US)

(72) Inventors: George Moser, Brighton, MI (US); Adam Ostapowicz, Orchard Lake Village, MI (US); Lawrence C. Kennedy, Baldwin, MI (US); Randy Linn, Charlotte, MI (US)

(73) Assignee: COOPER-STANDARD AUTOMOTIVE, INC., Novi, MI (US)

(21) Appl. No.: 13/536,287

(22) Filed: Jun. 28, 2012

Related U.S. Application Data
(63) Continuation-in-part of application No. 12/874,334, filed on Sep. 2, 2010.

(51) Int. Cl. F28D 1/06; F15D 1/00

(52) U.S. Cl. 165/148; 137/561 R

(57) ABSTRACT

A heat exchanger includes a first header tank, a second header tank, and a core. The core is positioned between the first header tank and the second header tank. The core includes a plurality of tubes, a set of cooling fins and a plurality of channels. Each tube of the plurality of tubes provides fluid communication between the first header tank and the second header tank. The set of cooling fins are located between the heat exchange tubes of the plurality of tubes to increase a heat exchange area. The plurality of channels is defined by the plurality of tubes and the set of cooling fins. The channels of the plurality of channels are operative for directing a flow of air through the core such that a flow of air enters a front face of the core in a first direction and is generally directed toward a plane.

### CROSS-REFERENCE TO RELATED APPLICATION

This application claims priority to U.S. Ser. No. 12/874,334 filed Sep. 2, 2010. The disclosure of this application is incorporated by reference as if fully set forth here.

### TECHNICAL FIELD

The present teachings generally relate to heat exchangers. More particularly, the present teachings relate to cooling systems for internal combustion engines.

### INTRODUCTION

This section provides background information related to the present disclosure which is not necessarily prior art.

Various heat exchangers are used in modern vehicles to transfer thermal energy from one medium to another for the purpose of cooling or heating. In this regard, it is necessary to cool various components of a motor vehicle to avoid overheating. As one example, a heat exchanger takes the form of a cooling radiator for an internal combustion engine.

A conventional radiator cools an internal combustion engine by passing a coolant through the engine block where it is heated. The coolant is fed into an inlet tank of the radiator which distributes the coolant through radiator tubes to an outlet tank. An airflow pulled by a cooling fan circulates across the radiator using the air to extract heat from the radiator and transfer it to the atmosphere. The colder coolant is fed back to the engine and the cycle repeats. The coolant is usually water-based, with addition of glycol to prevent freezing and other additives to limit corrosion.

As the coolant circulates through the tubes, it transfers its heat to the tubes. In turn, the tubes transfer part of the heat to fins that are positioned between each row of tubes. The purpose of the fins is to increase the total heat transfer area because the tubes generally do not provide enough cooling area. Both the tubes and the fins release heat to the ambient air. The heat released by the tubes is referred to as primary heat transfer, while the heat released by the fins is referred to as secondary heat transfer. Primary heat transfer is generally more efficient than secondary heat transfer because the heat has to travel only from the coolant to the tube and then to the air, which is a short path. The secondary heat transfer is generally less efficient because the heat has to travel from the coolant to the tube, then from the tube to the fin (across an imperfect brazed joint) and then from the fin to the air, which is a much longer and restrictive path. Still, it is necessary to supplement the tubes with the less efficient fins because the tubes do not provide enough heat exchange area.

Because air has a lower heat capacity and density than liquid coolants, a fairly large volume flow rate must pass through the radiator core to sufficiently extract heat from the coolant. Radiators have one or more fans that draw air through the radiator. To save fan power consumption in vehicles, radiators are often behind the grille at the front end of a vehicle. Ram air provides a portion of the necessary cooling air flow.

Because of dramatically increased fuel efficiency standards in Europe, in the United States and most of the world (almost double the fuel mileage is being targeted), much tougher emission regulations and higher heat transfer needs due to smaller, higher speed engines with higher compression and increased use of exhaust gas recirculation, a need for substantial improvement exists in the automobile industry for heat exchangers that can provide higher heat transfer, lower weight, smaller area and ability to absorb a substantially higher heat load.

### SUMMARY

This section provides a general summary of the disclosure, and is not a comprehensive disclosure of its full scope or all of its features.

In accordance with one particular aspect, the present teachings provide a heat exchanger including an inlet tank, an outlet tank, and a core. The core is positioned between the inlet tank and the outlet tank. The core includes a plurality of tubes, a set of cooling fins and a plurality of channels formed between the tubes and the fins. Each tube of the plurality of tubes provides fluid communication between the inlet tank and the outlet tank. The set of cooling fins are located between the heat exchange tubes of the plurality of tubes to increase a heat exchange area. The plurality of channels is defined by the plurality of tubes and the set of cooling fins. In a conventional radiator, the airflow crosses the radiator core in a straight line pattern. In accordance with the present teachings, the channels of the plurality of channels are operative for directing a flow of air through the core such that a flow of air enters a front face of the core in a first direction and exits the core in a different direction. The change of direction causes air turbulence and direct impingement of the air upon the core, resulting in a substantially higher heat transfer efficiency. In certain preferred embodiments, the change of direction is achieved by tubes made with a non-straight shape, in some cases shaped like a V, or like a curve, or other non-straight shapes. One of the key advantages of this approach is that it relies largely on primary heat exchange rather than secondary heat exchange to increase heat transfer efficiency.

In accordance with another particular aspect, the present teachings provide a heat exchanger with a core having a first group of air channels and a second group of air channels. The first group of air channels is disposed on a first side of an imaginary plane. The second group of air channels is disposed on a second side of the imaginary plane. The first and second groups of air channels both converge toward the imaginary plane as the air channels extend from a front side of the heat exchanger to a rear side of the heat exchanger. This convergence can be used to focus and orient the air exiting the radiator in the direction of the cooling fan, thus increasing fan efficiency and reducing power consumption.

In accordance with another particular aspect, the present teachings provide a radiator for a motor vehicle. The radiator includes first and second header tanks, a plurality of tubes and a plurality of fins. The plurality of tubes extends between the first and second header tanks and fluidly connects the first and second header tanks for transferring a medium to be cooled there between. The plurality of fins defines multiple groups of air channels that bias the airflow in different directions for redirecting the airflow in a plurality of predetermined directions. These predetermined directions may include left, right, up and down, and/or others in order to orient the airflow in a desired direction, such as toward the cooling fan, or toward the air exit of the under the hood engine compartment.

In accordance with yet another particular aspect, the present teachings provide a method of manufacturing a fin for a heat exchanger. The method includes providing a metal strip, such as aluminum fin stock, having a width and a length, and stamping the strip to define at least one hinge axis extending parallel to the length of the metal strip. The method additionally includes pleating the metal strip to create a plurality of fold lines perpendicular to the length of the metal strip. The method further includes bending a first portion of the metal strip relative to a second portion of the metal strip about a first hinge axis of the at least one hinge axis.

According to still yet another aspect, the present teachings provide a method of improving the flow of air through a radiator. The radiator has a plurality of channels defined by a plurality of tubes and a plurality of fins. The radiator assembly includes a shroud for directing the air toward a fan assembly, the method comprising:

generally directing a first flow of the air toward the first plane with a first group of channels, the first plane intersecting a fan drive of the fan assembly;

generally directing a second flow of the air toward the first plane with a second group of channels, the channels of the first group converging relative to the channels of the second group as the channels of the first and second groups extend from a front side of the radiator to a rear side of the radiator; and

creating turbulence proximate the fan drive with the first and second groups of generally directed air to thereby break away a boundary layer of air molecules adjacent to the fan drive. The boundary layer may be a stationary or low-speed boundary layer.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a front view of a heat exchanger constructed in accordance with the present teachings.

FIG. 2 is a simplified top view of the heat exchanger of FIG. 1, the heat exchanger shown operatively associated with an engine/transmission of a motor vehicle.

FIG. 3 is a side view of a portion of the core of the heat exchanger of FIG. 1.

FIG. 4 is a front view of the portion of the core of FIG. 3.

FIG. 5 is a simplified front view of another heat exchanger constructed in accordance with the present teachings.

FIG. 6 is a simplified top view of the heat exchanger of FIG. 5, the heat exchanger shown operatively associated with an engine/transmission of a motor vehicle.

FIG. 7 is a simplified side view of the heat exchanger of FIG. 5, the heat exchanger again shown operatively associated with an engine/transmission of a motor vehicle.

FIG. 8 is a simplified front view of another heat exchanger constructed in accordance with the present teachings.

FIG. 9 is a simplified side view of the heat exchanger of FIG. 8, the heat exchanger shown operatively associated with an engine/transmission of a motor vehicle.

FIG. 10 is a side view of the metal strip of FIG. 1 before shaping to conform with tubes.

FIG. 11 is a side view similar to FIG. 10, illustrating the fin after shaping to conform with the tubes.

FIG. 12 is a side view of another tube in accordance with the present teachings.

FIG. 13 illustrates the general steps of a method of manufacturing a fin in accordance with the present teachings.

FIG. 14 is a top view of a metal strip for making a fin in accordance with the method of the present teachings.

FIG. 15 is a top view of the metal strip of FIG. 14 after stamping.

FIG. 16 is a simplified prior art view illustrating airflow through a typical heat exchanger.

FIG. 17 is a simplified view illustrating airflow through a heat exchanger constructed in accordance with the present teachings to include angled tubes.

FIG. 18 is a simplified view similar to FIG. 17 illustrating a “cloud” of air molecules that may form on a front side of the heat exchanger.

FIG. 19 is another simplified view illustrating airflow through a heat exchanger constructed in accordance with the present teachings to include angled tubes.

FIG. 20 is another simplified view illustrating airflow through a heat exchanger constructed in accordance with the present teachings to include angled tubes. In the embodiment illustrated, the angling of the tubes is achieved through a gradual curve shape.

FIG. 21 is a simplified front view of another heat exchanger in accordance with the present teachings.

FIG. 22 is a simplified top view of the heat exchanger of FIG. 21.

FIG. 23 is a simplified front view of another heat exchanger in accordance with the present teachings.

FIG. 24 is a simplified top view of the heat exchanger of FIG. 23.

### DETAILED DESCRIPTION OF VARIOUS ASPECTS

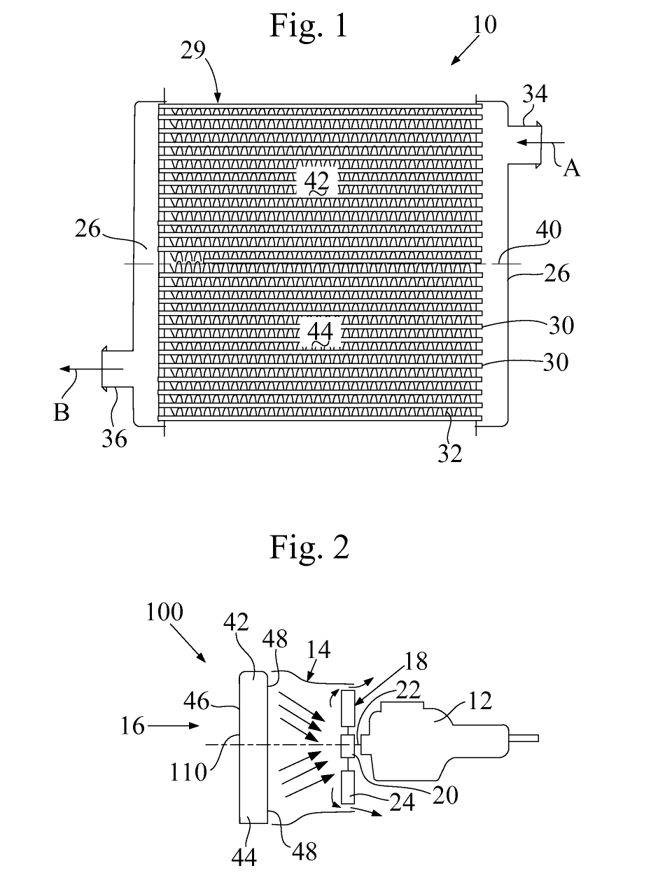

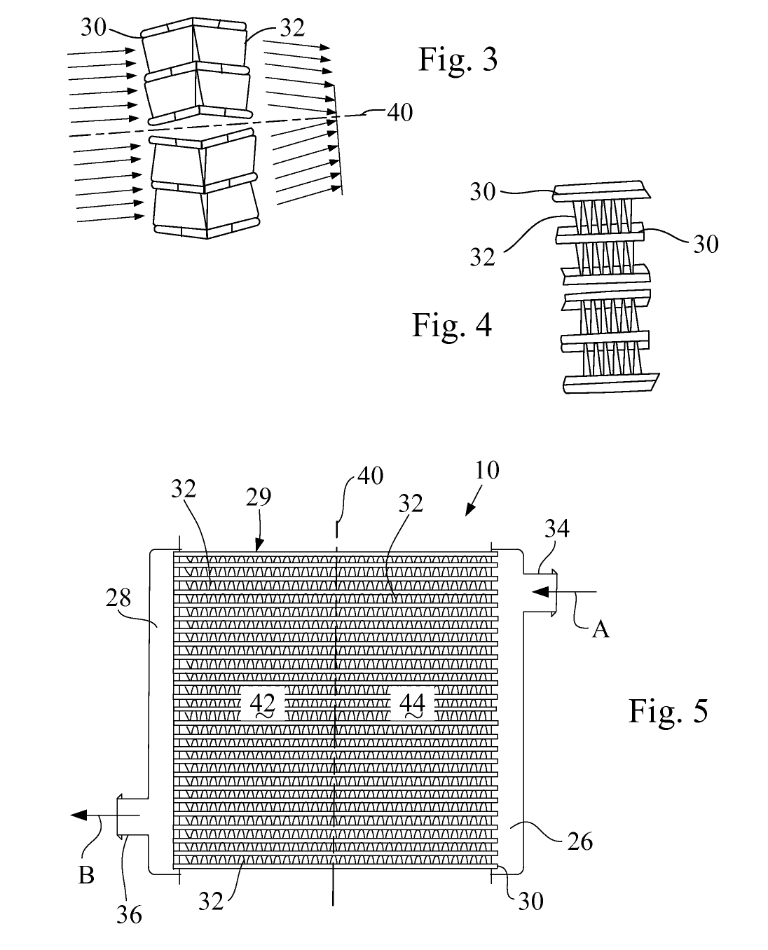

With initial reference to FIGS. 1 and 2, a heat exchanger constructed in accordance with the present teachings is illustrated at generally identified at reference character 10. In the embodiment illustrated, the heat exchanger 10 is illustrated as a radiator for a motor vehicle. In FIGS. 2 and 3, the heat exchanger 10 is shown operatively associated with an engine/transmission 12 of a motor vehicle. It will be understood that the present teachings are not limited to the exemplary embodiment(s) shown in the drawings and described herein. In this regard, the present teachings may be adapted for the cooling of various media within a motor vehicle. In addition, the present teachings may also be readily adapted for non-automotive applications. The heat exchanger may be selected from a including but not limited to a radiator, a condenser, an evaporator, an engine oil cooler, and a transmission oil cooler.

Before addressing details of the construction and operation of the heat exchanger 10 of the present invention, an understanding of the exemplary use environment shown in the drawings is warranted. It will be understood that details of the exemplary use environment not specifically described herein are conventional in both construction and operation. FIG. 2 uses an engine-mounted cooling fan configuration as an example. This configuration is typically used for trucks. An alternative configuration would be a radiator-mounted electric fan assembly, which is typically used in passenger cars. It will be understood that the present teachings apply to both of these possible configurations.

A shroud 14 is positioned between the heat exchanger 10 and the engine/transmission 12. The shroud 14 functions to collect and direct air passing through the heat exchanger 10 toward a fan assembly 18. The shroud 14 conventionally tapers from a front side to a rear side.

The fan assembly 18 operates to draw air through the heat exchanger 10. The fan assembly includes a fan drive 20 driven by a shaft 22 extending from the engine 12. The fan drive 20 holds and drives the fan24. Conventionally, a significant amount of heat is generated at the fan drive 20. Also conventionally, air molecules are impinged against the fan drive 20 and the root of the fan blade hub. This impingement creates a boundary layer of stagnant air that may impede or constrain the flow of air 16 through the heat exchanger 10.

With continued reference to FIGS. 1 through 4 of the drawings, the heat exchanger 10 of the present teachings will be further detailed. The heat exchanger 10 is illustrated to generally include first and second tanks 26 and 28 and a core 29. The core 29 includes a plurality of tubes 30 and a plurality of fins 32. The first tank 26 receives a medium to be cooled from the engine/transmission 12 in the direction of arrow A. The medium may be coolant. The medium to be cooled enters the first tank 26 through an input port 34. The second tank 28 defines an output port 36 through which cooled medium is directed to the engine/transmission 12 in the direction of arrow B.

The plurality of tubes 30 extends between the first and second tanks 26 and 28. The tubes 30 fluidly connect the first and second tanks 26 and 28 for transferring the medium to be cooled there between. In the embodiment illustrated, the tubes 30 are oriented horizontally between the vertically oriented header tanks 26 and 28. The tubes are in direct contact with the coolant and therefore serve as the primary structure for removing heat from the coolant.

A fin 32 is located between each adjacent pair of tubes 30. As such, the fins 32 each extend in a generally horizontal direction. Each fin 32 cooperates with the adjacent tubes 30 to define a plurality of channels for directing the flow of air 16 through the heat exchanger 10. The fins 32 are indirectly in contact with the coolant and define secondary structure for removing heat from the coolant.

As will become apparent herein, the fins 32 and tubes 30 cooperate to generally direct the air 16 through the heat exchanger 10 such that a flow of air enters a front face of the core 29 in a first direction (i.e., in the direction indicated by the arrow associated with reference character 16) and is biased in at least a second direction. In the embodiment illustrated, the airflow may be generally directed toward an imaginary plane 40. The plane 40 may be parallel to the direction 16. In the embodiment illustrated, the plane 40 toward which the air 16 is generally directed is horizontally oriented and intersects the fan drive 20. Alternatively and as will be addressed further below, the plane 40 toward which the air 16 is directed may be horizontally oriented.

As shown in the front view of FIG. 1, the plane 40 generally bisects a core of the heat exchanger 10 in a horizontal direction. A first group of channels 42 defined by the plurality of fins 32 and plurality of tubes 30 are disposed on a first side of the plane 40 (i.e., above the plane 40 as illustrated in FIG. 1). A second group of channels 44 defined by the plurality of fins 32 and the plurality of tubes 30 are disposed on a second, opposite side of the plane 40 (i.e., below the plane 40 as illustrated in FIG. 1).

With reference to the simplified side view of FIG. 2, the first and second groups of air channels 42 and 44 both generally converge toward the first imaginary plane 40 as the air channels 42 and 44 extend from a front side 46 of the heat exchanger 10 to a rear side 48 of the heat exchanger 10. As will become apparent, in the embodiment illustrated the geometry of the tubes 30 serves to generally converge the flow of air toward the plane 40. In other embodiments (some of which are described below), the configuration of the fins may generally converge the flow of air toward a plane.

As illustrated in FIG. 2, the channels 42 and 44 defined by the fins 32 and tubes 30 linearly converge toward plane 40. It will be understood, however, that the channels 42 and 44 may non-linearly converge in alternative embodiments. In this regard, various other fin shapes may be used. Any fin shape suitable for generally directing the air 40 toward the plane 40 may be utilized within the scope of the present teachings.

As perhaps best shown in the partial side view of FIG. 3, the tubes 30 may be bent to generally converge the flow of air. As illustrated, the tubes 30 may include two or more generally planar segments. In the particular embodiment shown, the tubes 30 include two planar segments. Fins 32 suitable for use with the bent tubes 30 will be further described below.

As the motor vehicle moves, air 16 enters the front side 46 of the heat exchanger 10 in a direction generally perpendicular thereto. The angled channels 42 and 44 function to increase contact between the air 16 and the tubes 30 and further function to generally direct the flow of the air 16 toward the plane 40. By generally concentrating the air 16 toward the plane 40 proximate the fan drive 20, turbulence is created to break away the thermal boundary layer of air molecules adjacent the fan drive 20. As a result, heat transfer (and thus heat dissipation) at the fan drive 20 is greatly improved. Fan performance may be improved as turbulent air is pulled along the roots of the radial flow fan blades.

Turning to FIGS. 5-7, another heat exchanger constructed in accordance with the present teachings is illustrated and identified at reference character 10′. The heat exchanger 10′ differs from the heat exchanger 10 in that the flow of air 16 is generally directed toward a first plane 40′ that is vertically oriented and that the geometries of the fins 32 function to generally divert the flow of air 16. Given the similarities between the heat exchangers 10 and 10′, like reference characters will be used to identify similar elements.

As shown in the front view of FIG. 5, the plane 40′ generally bisects the core 29 of the heat exchanger 10′ in a vertical direction. A first group of channels 42′ defined by the plurality of fins 32 and plurality of tubes 30 are disposed on a first side of the plane 40′ (i.e., to the left of the plane 40 as illustrated in FIG. 1). A second group of channels 44′ defined by the plurality of fins 32 and the plurality of tubes 30 are disposed on a second, opposite side of the plane 40′ (i.e., to the right as illustrated in FIG. 1).

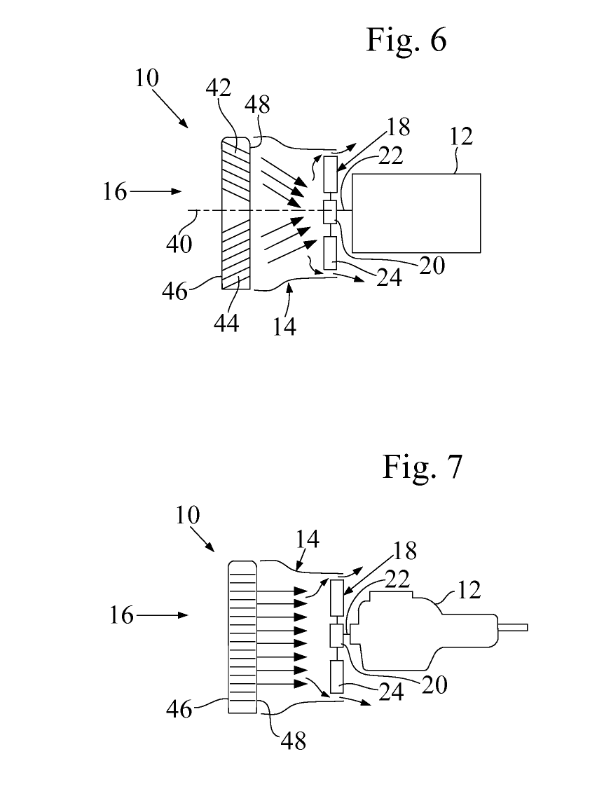

With reference to the simplified top view of FIG. 6, the first and second groups of air channels 42′ and 44′ both converge toward the first imaginary plane 40′ as the air channels 42 and 44 extend from the front side 46 of the heat exchanger 10 to the rear side 48 of the heat exchanger 10. In the embodiment illustrated, the channels 42 and 44 defined by the fins 32 are oriented at common angles relative to the plane 40′. In alternative embodiments, the angles of the channels 42 and 44 may vary. In this regard, the angles of the channels 42 and 44 relative to the plane 40′ may be greater (e.g., more aggressive) as the lateral distance from the plane 40′ increases for purposes of concentrating the flow of air 16 toward the plane 40′.

As illustrated in FIG. 6, the channels 42 and 44 defined by the fins 32 and tubes 30 linearly converge toward plane 40′. As above, it will again be understood that the channels 42 and 44 may non-linearly converge in alternative embodiments. Any fin shape suitable for generally directing the air 40′ toward the plane 40′ may be utilized within the scope of the present teachings.

As the motor vehicle moves, air 16 enters the front side 46 of the heat exchanger 10 in a direction generally perpendicular thereto. The angled channels 42 and 44 function to increase contact between the fins 32 and further function to generally direct the flow of the air 16 toward the plane 40′. By generally concentrating the air 16 toward the plane 40 proximate the fan drive 20, turbulence is created to break away the thermal boundary layer of air molecules adjacent the fan drive 20.

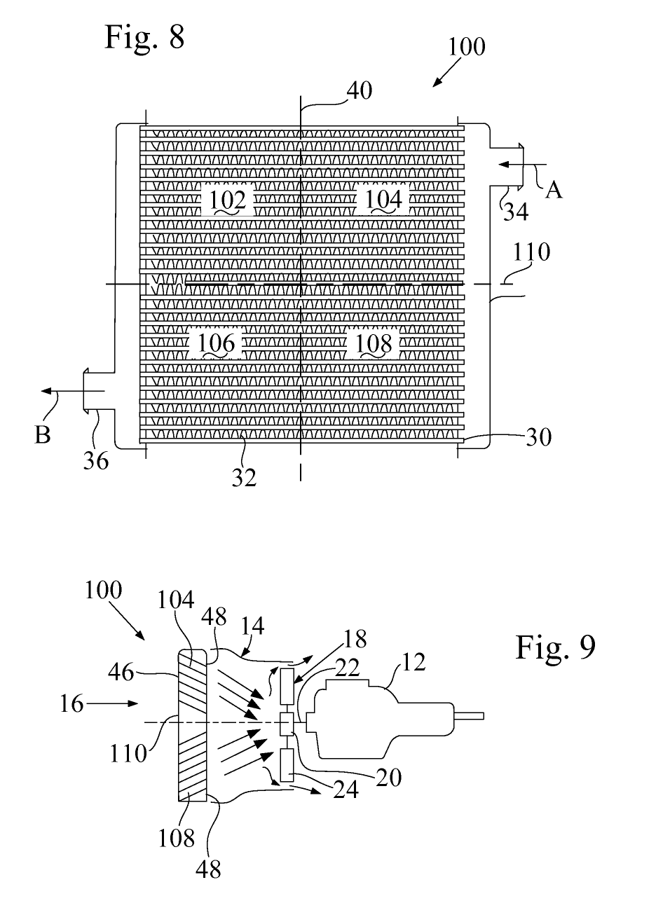

Turning now to FIGS. 8 and 9, another heat exchanger in accordance with the present teaching is illustrated and generally identified at reference character 100. The heat exchanger 100 differs from the heat exchanger 10 in that the air 16 is generally directed to a point rather than a plane. Given the similarities between the heat exchanger 10 and the heat exchanger 100, like reference characters will be used throughout the views to identify similar elements.

It will be understood that to the extent not described herein, details of the heat exchanger 100 are similar to corresponding details of the heat exchanger 10. For example, the simplified view of FIG. 6 equally applies to the heat exchanger 100.

As shown in the front view of FIG. 8, the channels defined by the fins 32 and tubes 30 may be divided into four distinct groups of channels 102, 104, 106 and 108. These groups of channels 102-108 may be divided by a first imaginary plane 40 and a second imaginary plane 110.

As shown in the front view of FIG. 4, the first plane 40 generally bisects the core of the heat exchanger 100 in a horizontal direction. The second plane 110 generally bisects the core of the heat exchanger 100 in a vertical direction. A first group of channels 102 is disposed on a first side of the first plane 40 (i.e., to the left of plane 40 in FIG. 4) and on a first side of the second plane 102 (i.e., above the plane 110 in FIG. 4). A second group of channels 104 is disposed on a second, opposite side of the first plane 40 (i.e., to the right of plane 40 in FIG. 4) and on the first side of the second plane 102. A third group of channels 106 is disposed on a first side of the first plane 40 and on a second side of the second plane 102 (i.e., below the plane 110 in FIG. 4). A fourth group of channels 108 is disposed on the second side of the first plane 40 (i.e., to the right of plane 40 in FIG. 4) and on the second side of the second plane 102.

Similar to that shown in the top view of FIG. 6 for the heat exchanger 10′, the first, second, third, and fourth groups of channels 102-108 all converge toward the plane 40 as the channels extend from the front side 46 of the heat exchanger 100 to the rear side 48 of the heat exchanger 100.

With reference to the simplified side view of FIG. 9, the second and fourth groups of channels 104 and 108 may generally converge toward the plane 110 as the channels extend from the front side 46 to the rear side 48 of the heat exchanger 100. It will be understood that the opposite side to that shown in FIG. 5 is a mirror image thereof. In this regard, the channels of the first and third groups of channels 102 and 106 similarly, generally converge toward the plane 110 as the channels extend from the front side 46 to the rear side 48. Otherwise stated, the channels 102-108 all converge toward the plane 110 as the channels extend from the front side 46 to the rear side 48 of the heat exchanger 100.

As the motor vehicle moves, air 16 enters the front side 46 of the heat exchanger 110. The channels function to generally converge the flow of air 16 both toward the plane 40 and toward the plane 110. As a result, the flow of air 16 is generally directed to (or converges toward) a point. This point may be proximate the fan drive 20 for purposes of breaking away the thermal boundary layer of air molecules adjacent to fan drive, as discussed above with respect to the heat exchanger 10′.

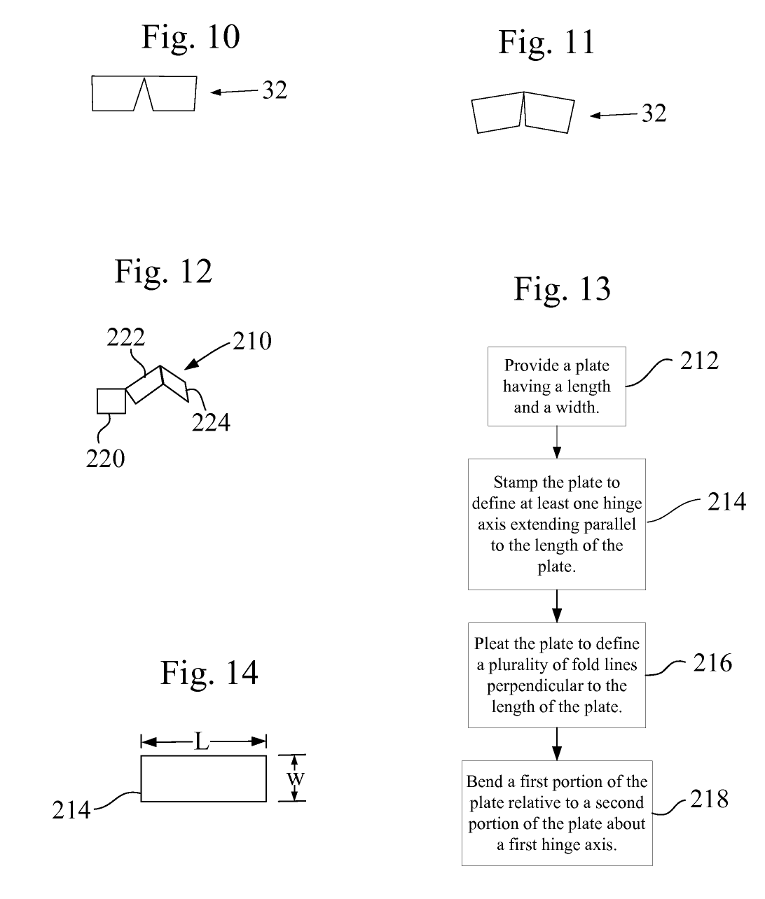

Reference will now be made to FIGS. 9 and 10. Where the tubes 30 are bent as discussed above with respect to the heat exchanger 10, it will be necessary to correspondingly shape the fins 32 between adjacent tubes 30 for secondary cooling. A side view of one suitable fin 32 is shown in FIG. 9 prior to bending. FIG. 10 illustrates this fin 32 after bending.

In certain applications, it may be desirable to provide the tubes 30 of the heat exchanger 10 with a more complex shape. For example, the tubes may define a lead-in having a segment that is generally parallel with the flow of air into the front of the heat exchanger 10.

With reference to FIG. 12, another side view of a fin 210 in accordance with the present teachings is illustrated. This fin 210 may be used with such an alternative arrangement in which the tubes define a lead-in. The fin 210 differs from the fin 32 discussed above in that the fin 210 includes three generally planar segments. A method of manufacturing the fin 210 in accordance with the present teachings will be described below with reference to FIG. 13.

In accordance with a first general step 212, a metal strip 214 is provided having a length l and a width w. The metal strip is illustrated in FIG. 9.

In accordance with a second general step 215, the metal strip 214 is stamped or otherwise suitably formed to define at least one hinge axis extending parallel to the length l of the metal strip 214. In the embodiment illustrated, the metal strip 214 is stamped to include first and second hinge axes. In this regard, the metal strip 214 is stamped to include a row of diamond shaped openings and a row of slots. The second hinge axis extends through the centers of the diamond shaped openings and parallel to the first hinge axis.

In accordance with a third general step 216, the stamped metal strip 214 is pleated to define a plurality of fold lines perpendicular to the length l of the metal strip 214. The step of pleating may be carried out in a conventional manner with rollers.

In accordance with a fourth general step 218, a first portion 220 of the metal strip 214 is bent relative to a second portion 222 of the metal strip 214 about the first hinge axis. The reduced material between adjacent slots facilitates bending of the metal strip 214 about the first hinge axis. In the embodiment illustrated, a third portion 224 is bent relative to the second portion 222 about the second hinge axis. Again, the reduced material between adjacent diamond shaped openings facilitates bending of the metal strip 214. The openings permit downward bending of the third portion 224 (as shown in FIG. 7).

It will be appreciated that the present teachings provide a heat exchanger with features that can individually or in combination provide a significant increase in heat transfer performance. Such an increase in thermal performance can be used to design a heat exchanger with reduced frontal area, radiator thickness, weight, and cost. Additionally or alternatively, a smaller fan drive may be utilized and/or a smaller fan may be used. Smaller components may provide for improved styling flexibility.

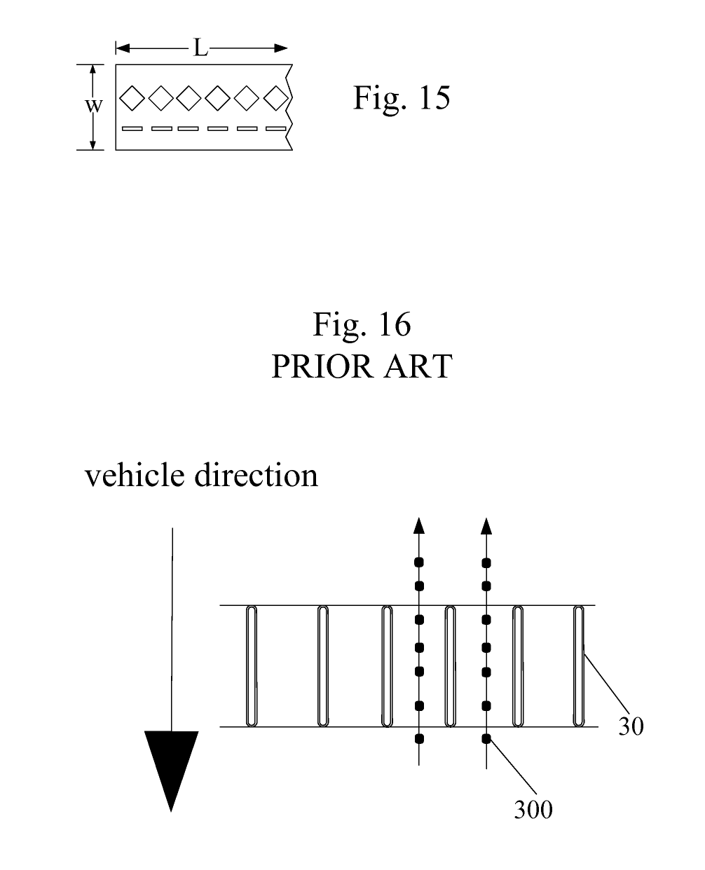

With general reference to FIGS. 15-25, various simplified views are provided to further explain aspects of the present invention. Like reference characters will be used to refer to previously introduced elements.

The angled tube heat exchanger of the present teachings seeks to enhance heat exchange by making the airflow through a heat exchanger non-straight by shaping the tubes 30 in a way that the air paths through the heat exchanger force the air to impinge on the heat exchange areas of the heat exchanger (fins and tubes) as opposed to just flow mostly parallel to these heat exchange areas.

By forcing the air to change direction through the non-straight tube geometry a turbulent flow can be created and a direct impingement of the air on the heat exchange surfaces is achieved, which leads to a significantly better heat transfer. It is important, however, to ensure that the heat exchanger does not become too restrictive to the airflow and that any pressure drop across the radiator is not too significant. Otherwise, a more powerful cooling fan to draw air through the heat exchanger may be required. Such a more powerful fan would consume more energy, which is contrary to the target of reducing all parasitic losses in a vehicle to maximize a heat exchanger fuel efficiency and minimize emissions. The present teachings provide different tube configurations that increase heat transfer without unduly increasing pressure drop.

Before addressing the present teachings, a comparison analysis of a typical heat exchanger is warranted. FIG. 16 shows that in a conventional heat exchanger the air molecules 300 have a very low probability of actually touching the tubes 30. Most of the airflow can go relatively undisturbed between the tubes 30 and the fins 32 of the core. This situation creates inefficient heat transfer.

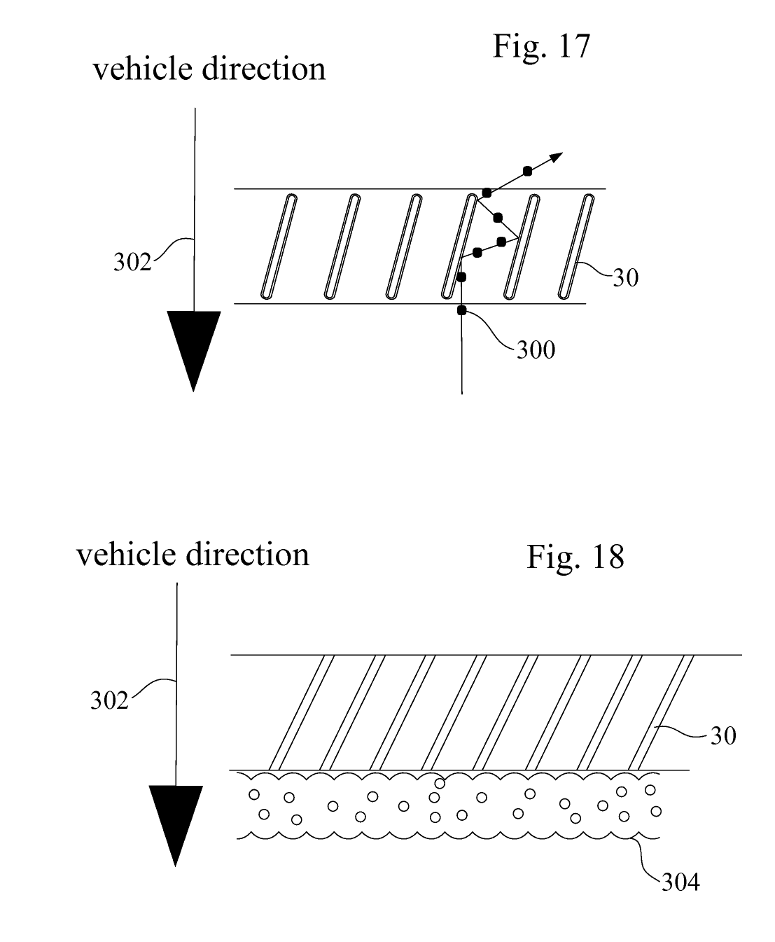

FIG. 17 shows that by slanting the tubes 30 by a certain angle, an angled airflow path is created that forces the air molecules 300 to collide against the tubes 30 and the fins 32 of the channels, destroying laminar flow boundaries, bouncing around and creating turbulence that enhances heat transfer. The arrow 302 shows the direction of travel of the vehicle.

FIG. 18 illustrates an unintended consequence: a “cloud” 304 of air molecules forms in front of the vehicle because of air molecules being bounced back by the movement of the vehicle when they collide against the radiator. Not all molecules are bounced in an angle toward the inside of the radiator. Many molecules are just thrown back out of the radiator, creating the cloud of air molecules 304, which represents an obstacle to the air getting into the radiator. The vehicle pushes this cloud in front of it, which is undesirable because it acts like a brake on the vehicle and also makes it harder for air to enter the radiator, increasing the pressure drop across the radiator.

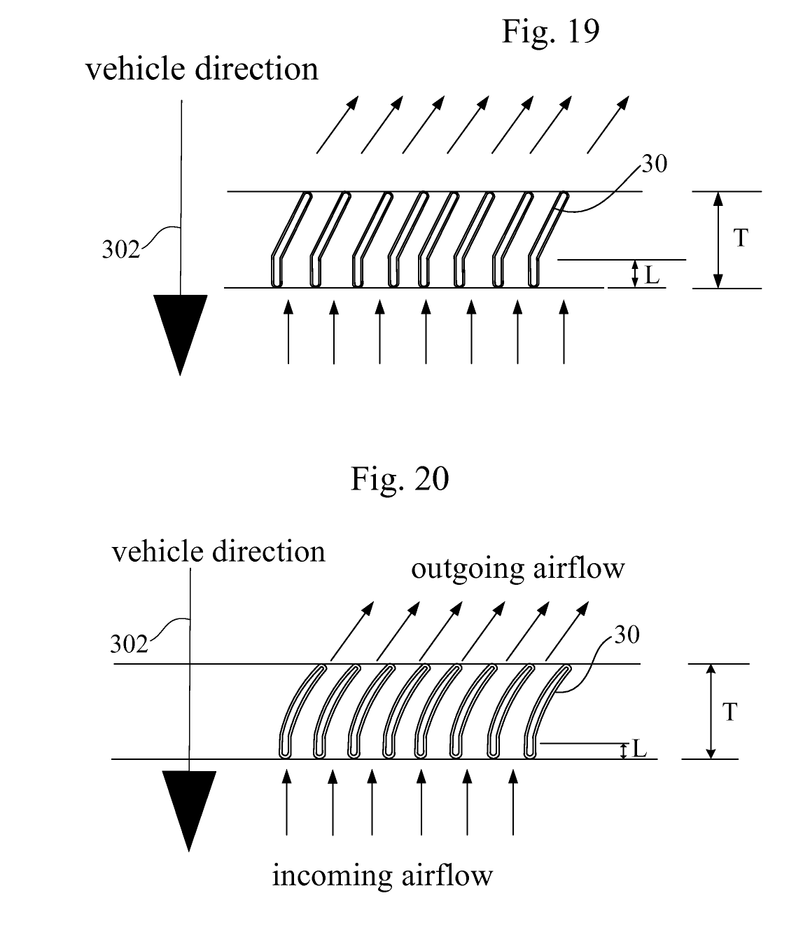

Experiments and tests have shown that the right geometry can partially or completely overcome this obstacle. FIG. 19 shows that if the tubes 30 are designed with a straight portion in the front, the cloud 304 shown in FIG. 18 may be reduced or may disappear because the air is allowed to enter the radiator before starting to force it to change direction. The pressure drop and the air resistance are dramatically reduced with this configuration. This effect is so significant that without it the angled tube 30 approach may be of very limited practical value for a vehicle application (it still could work well for stationary applications, but not necessarily for mobile applications such as a vehicle radiator). Further experiments showed that the straight portion of the tube (called the lead-in) has to have a minimum length L for it to work. If L is too short, the obstacle cloud starts developing again. If L is too long, no cloud develops, but the heat transfer deteriorates. In certain applications, the length L that worked best was between 0.2 to 0.4 times the total radiator thickness T. A good value in many tests tuned out to be 0.3 T.

FIG. 20 illustrates another tube arrangement in accordance with the present teachings. As illustrated, tubes 30 are bent in a gradual, curved shape (as opposed to the abrupt bending of FIG. 19). The resultant pressure drop is further reduced in a substantial way. In certain applications, the minimum lead-in length L may be approximately 0.1 to 0.4 times the radiator thickness. A good value in many tests turned out to be 0.2 T.

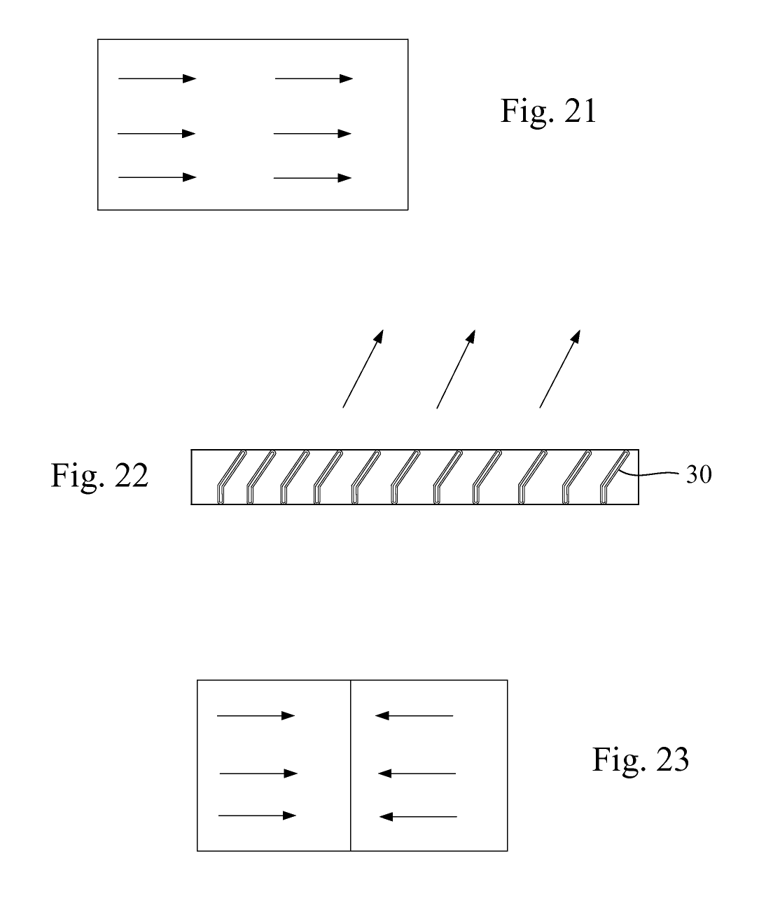

FIGS. 21 and 22 illustrate another embodiment of the present invention. In this embodiment, all the tubes 30 have the same angle. Therefore, the airflow is deflected laterally which is desirable in some situations. In other situations it may be desirable to orient the airflow toward the center of the cooling fan (instead of a laterally shift of the airflow). In all those cases, the angled tube heat exchanger allows a degree of airflow management heretofore not available.

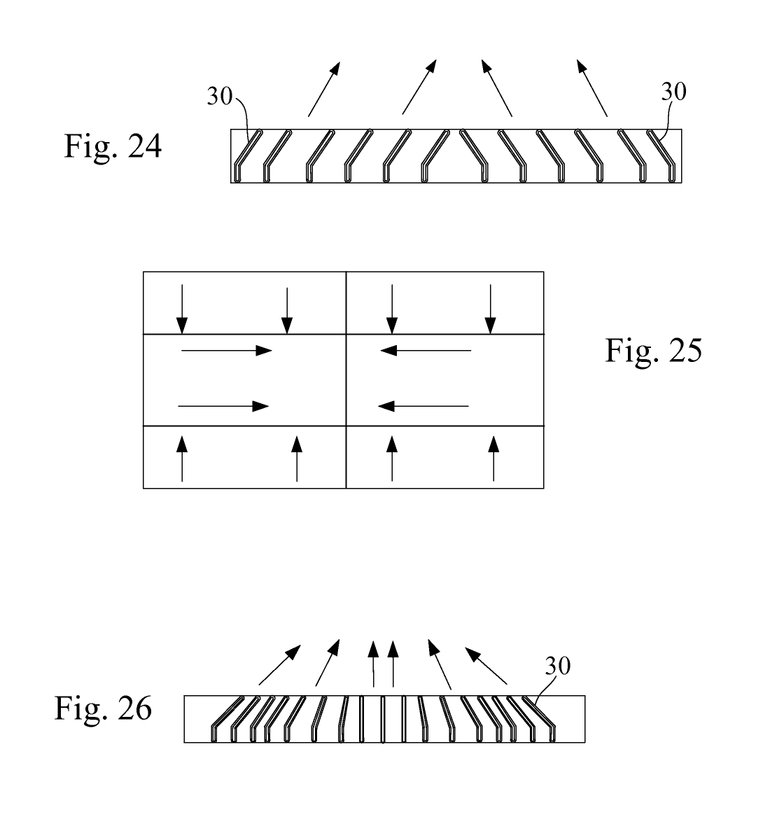

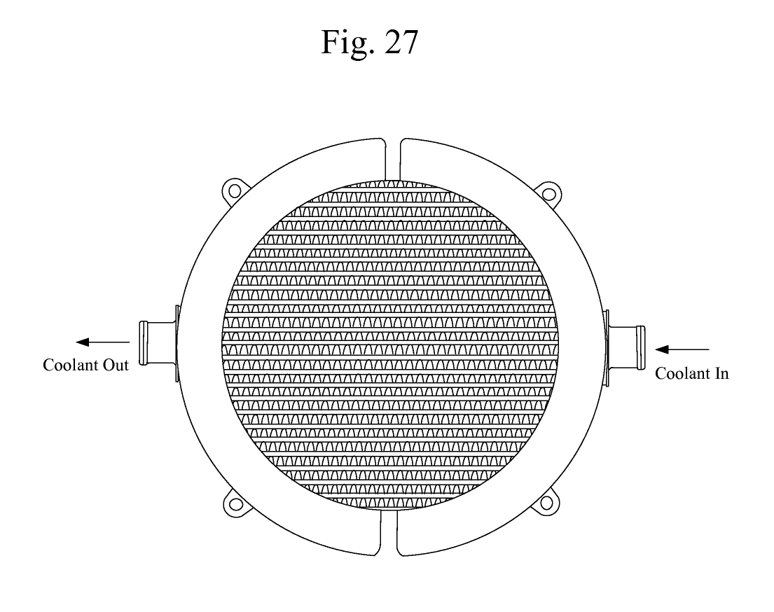

FIGS. 23 and 24 illustrate a radiator in accordance with the present teachings that has two portions, each with tubes 30 oriented in opposite directions. Therefore, one portion of the radiator deflects the air toward the right side, while the other portion deflects the air toward the left side. The result is a focused and centered airflow, which can substantially increase the efficiency of the cooling fan.

FIGS. 25 and 26 illustrate another radiator in accordance with the present teachings. In this embodiment, the radiator includes four sections. Two of the sections center the airflow in horizontal direction, while the two other sections orient the airflow in vertical direction. The result is airflow focused on the fan from all directions, which further increases fan efficiency.

As shown in FIG. 26, the tube angle does not have to be constant. This figure shows a variable angle, with the angle almost zero near the center and becoming much more larger in the periphery. This variable tube geometry may achieve an even better focusing of the airflow.

Turning finally to FIG. 27, another radiator constructed in accordance with the present teachings is illustrated. As shown, the radiator has a circular shape to closely match the shape of the cooling fan. The core of the radiator may be constructed to include any of the angled tube and/or angled fin constructions discussed above. In a front view, the inlet and outlet tubes are curved. As a result, the length of the tubes has a maximum dimension at a horizontal center of the radiator and decreases in both upper and lower directions.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A heat exchanger comprising:
an inlet tank;
an outlet tank; and
a core positioned between the inlet tank and the outlet tank, the core including:
a plurality of tubes, each tube of the plurality of tubes providing fluid communication between the inlet tank and the outlet tank,
a set of cooling fins located between the heat exchange tubes of the plurality of tubes to increase a heat exchange area,
a plurality of channels defined by the plurality of tubes and the set of cooling fins, the plurality of channels operative for directing a flow of air through the core such that a flow of air enters a front face of the core in a first direction and is generally directed toward a plane, the plane parallel to the first direction.

2. The heat exchanger of claim 1, wherein the heat exchanger is selected from a group consisting of a radiator, a condenser, an evaporator, an engine oil cooler, and a transmission oil cooler.

3. The heat exchanger of claim 1, wherein the plane is a horizontal plane.

4-5. (canceled)

6. The heat exchanger of claim 1, wherein the channels define non-straight paths for the flow of air through the core.

7. The heat exchanger of claim 1, wherein the non-straight paths of the channels is a result of the geometry of the tubes.

8. The heat exchanger of claim 4, wherein the cross-section of the tubes has a generally V-shape with at least two segments at an angle relative to one another, the tubes operative to force the flow of air to generally converge toward the plane.

9. The heat exchanger of claim 1, wherein the fins are configured to generally converge the flow of air toward the plane.

10. The heat exchanger of claim 1, wherein the channels are configured to generally direct the flow of air toward the plane and further configured to generally direct the flow of air toward at least one second plane.

11. A heat exchanger comprising:
a first group of air channels on a first side of an imaginary plane;
a second group of air channels on a second side of the imaginary plane;
wherein the first and second groups of air channels both converging toward the imaginary plane as the air channels extend from a front side of the heat exchanger to a rear side of the heat exchanger.

12. The heat exchanger of claim 11, wherein the air channels of the first and second groups of air channels linearly converge toward the imaginary plane.

13. The heat exchanger of claim 11, wherein the air channels of the first and second groups of air channels non-linearly converge toward to the imaginary plane.

14. The heat exchanger of claim 11, wherein the imaginary plane is vertically oriented.

15. The heat exchanger of claim 11, further comprising:
first and second tanks and a plurality of tubes extending between the first and second tanks and fluidly connecting the first and second tanks for transferring a medium to be cooled therebetween; and
a plurality of fins;
wherein the first and second groups of air channels are by the plurality of tubes, the plurality of fins, or both the plurality of tubes and the plurality of fins.

16. The heat exchanger of claim 15, wherein the first and second air channels are defined by the plurality of fins.

17. (canceled)

18. A radiator for a motor vehicle, the radiator comprising:
first and second tanks;
a core disposed between the first and second tanks, the core including a plurality of tubes and a plurality of fins;
the plurality of tubes extending between the first and second tanks and fluidly connecting the first and second header tanks for transferring a medium to be cooled therebetween;
the plurality of fins defining multiple groups for biasing an airflow through the core in different directions for redirecting the airflow in a plurality of predetermined directions of air channels on a first side of a first imaginary plane and a second group of air channels on a second side of the first imaginary plane, the first and second groups of air channels both converging toward the first imaginary plane as the air channels extend from a front side of the radiator to a rear side of the radiator.

19. The radiator for a motor vehicle of claim 18, wherein the air channels of the first and second groups of air channels linearly converge toward the first imaginary plane.

20. The radiator for a motor vehicle of claim 18, wherein the first imaginary plane is vertically oriented.

21. The radiator for a motor vehicle of claim 18, wherein the first imaginary plane is horizontally oriented.

22. The radiator for a motor vehicle of claim 20, further comprising a second, horizontally oriented imaginary plane, wherein:
the first and second groups of air channels are disposed above the second imaginary plane;
wherein the plurality of fins further define a third and fourth groups of air channels, the third group of air channels disposed below the second imaginary plane and on the first side of the first imaginary plane, the fourth group of air channels disposed below the second imaginary line and on the second side of the first imaginary plane;
the third and fourth groups of air channels both converging toward the first imaginary plane as the air channels extend from the front side of the radiator to the rear side of the radiator; and
the first, second, third and fourth groups of air channels all converging toward the second imaginary plane as the air channels extend from the front side of the radiator to the rear side of the radiator.

23. The radiator for a motor vehicle of claim 18, wherein the air channels of the plurality of air channels all generally converge toward a common plane.

24-38. (canceled)
